(19) United States
(12) Patent Application Publication
(10) Pub. No.: US 2008/0101703 A1
(43) Pub. Date: May 1, 2008

(54) SYSTEMS AND METHODS FOR RECOGNIZING SHAPES IN AN IMAGE

(75) Inventors: Stephen R. Shafer, Vestal, NY (US); Richard C. VanHall, Owego, NY (US)

Correspondence Address: BURNS & LEVINSON, LLP, 125 SUMMER STREET, BOSTON, MA, 02110, US

(73) Assignee: LOCKHEED MARTIN CORPORATION, Bethesda, MD (US)

(21) Appl. No.: 11/554,299

(22) Filed: Oct. 30, 2006

(51) Int. Cl. G06K 9/46; G06K 9/36

(52) U.S. Cl. 382/203; 382/284

(57) ABSTRACT

Methods and systems for recognizing shapes in an image.

### BACKGROUND

Many different image processing applications require searching the pixels of an image for shapes of objects. These objects may be stamps on an image of a piece of mail, nuts and bolts in a parts bin, or even characteristic shapes in a medical image. The shape may possibly show up at any orientation, or even as a different size, in the image. One approach to finding a shape in an image would be to examine an image using a template of the shape and match the pixels in the shape with pixels in the image. If the shape is not located, move to another location in the image and try again. Although this method works very well and can locate many different types of shapes, it can require a proportionately large amount of computer time, especially for those applications that have hard (or soft) real-time deadlines on producing an answer. For example, on a mail transport, between image lift and required answer there may be less than half a second,

Although a number of methods and algorithms have been developed for the problems of shape matching and template matching, the time required to solve the problem of finding a shape in an image, for many practical problems and for real-time applications, can present a barrier to implementation of the algorithm.

Therefore, there is a need to provide methods that can reduce the time required to search for a shape in an image. There is also a need for systems that implement methods that can reduce the time required to search for a shape in an image.

### BRIEF SUMMARY

In one embodiment, the method of these teachings includes tessellating the image, resulting in a tessellation comprising a number of tiles, each tile from the tessellation comprising a number of pixels. A measure of pixel value variation is obtained for every tile in the tessellation. For each tile from the tessellation, the measure of pixel variation is compared to a predetermined value in order to determine whether the measure is at least equal to or greater than the predetermined value. The application of a shape recognizing algorithm is controlled by whether the measure for each tile is at least equal to the predetermined value are identified.

In one embodiment, the shape recognizing algorithm is a template matching algorithm. In another embodiment, the shape recognizing algorithm is a shape matching algorithm.

Embodiments of systems for implementing the method and computer usable medium having computer readable code embodied therein to implement the method are also disclosed.

For a better understanding of the present teachings, reference is made to the accompanying drawings and detailed description and its scope will be pointed out in the appended claims.

### BRIEF DESCRIPTION OF THE DRAWINGS

FIG. 1 is a flowchart representation of an embodiment of the method of these teachings,

FIG. 2 is a graphical schematic representation of an exemplary embodiment of an image after one of the steps in an embodiment of the method of these teachings;

FIG. 3 is a graphical schematic representation of an exemplary embodiment of another image after another one of the steps in an embodiment of the method of these teachings;

FIG. 4 is a graphical schematic representation of a template after yet another one of the steps in an embodiment of the method of these teachings; and

FIG. 5 represents a block diagram representation of an embodiment of the system of these teachings.

### DETAILED DESCRIPTION

In one embodiment, the method of these teachings includes tessellating the image, resulting in a tessellation comprising a number of tiles, each tile from the tessellation comprising a number of pixels. A measure of pixel value variation is obtained for every tile in the tessellation. For each tile from the tessellation, the measure of pixel variation is compared to a predetermined value in order to determine whether the measure is at least equal to or greater than the predetermined value. The application of a shape recognizing algorithm is controlled by whether the measure for each tile is at least equal to the predetermined value.

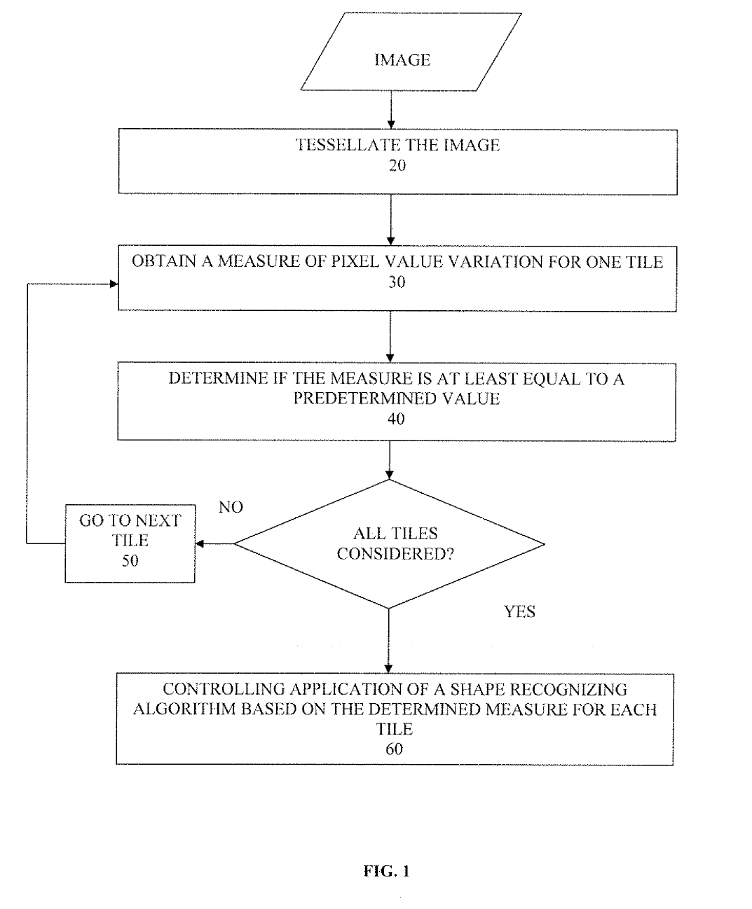

FIG. 1 is a flowchart representation of an embodiment of the method of these teachings. Referring to FIG. 1, in the embodiment of the method of these teachings shown therein, the method starts by tessellating an image (step 20, FIG. 1). A tessellation includes a number of tiles and each tile in the tessellation includes a number of pixels. For one tile in the tessellation, a measure of pixel variation is obtained (step 30, FIG. 1) and it is determined whether the measure is greater than or equal to a predetermined value (step 40, FIG. 1). The two preceding steps are repeated for every tile in the tessellation (step 50, FIG. 1). Finally, the application of a shape recognizing algorithm is controlled by the identified tiles (step 60, FIG. 1) . In one embodiment, those tiles in which the measure of pixel variation is less than the predetermined value are removed from consideration. In another embodiment, the application of the algorithm is dependent on the measure of pixel variation of a predetermined tile.

In one embodiment, these teachings not being limited to only that embodiment, tessellation comprises rectangular tiles. It should be noted that although rectangular tiles or square tiles may be preferable in some applications, other shapes, such as, for example, hexagonal tiles, may be preferable in other applications.

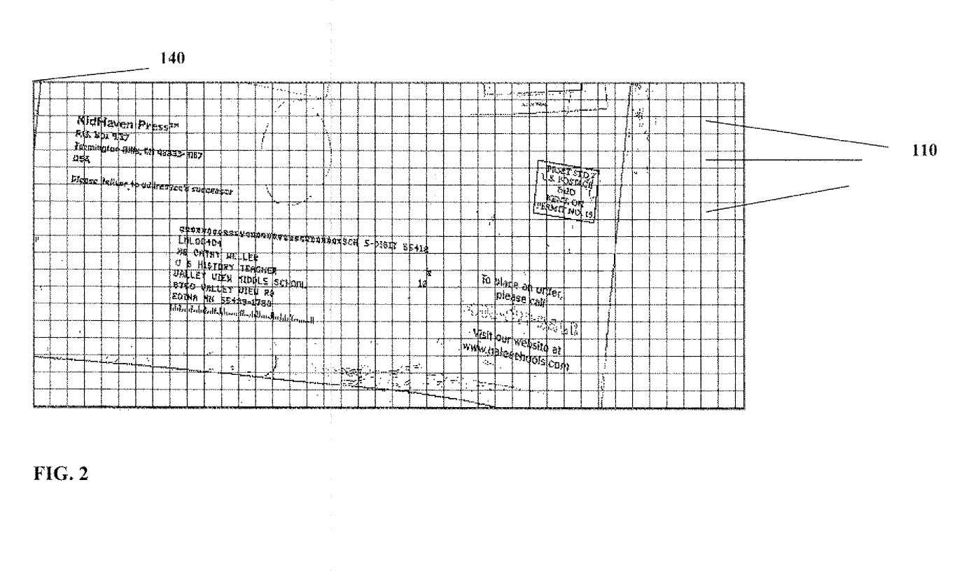

An exemplary embodiment (but not a limitation of these teachings) of an image partitioned into square tiles 110 is shown in FIG. 2.

In one embodiment, the measure of pixel value variation is the variance of the pixel values for the pixels in the tile.

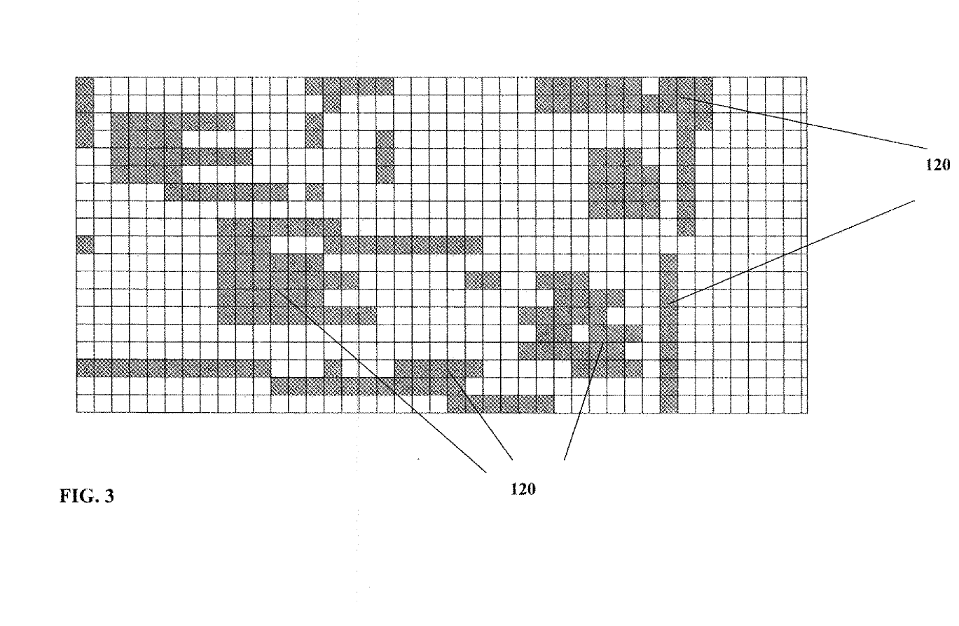

For the exemplary embodiment shown in FIG. 2, the measure of pixel variation (the variance in one instance) is calculated for each tile. In the exemplary embodiment, regions 120 are selected, where in each region the measure of pixel variation is greater than or equal to a predetermined amount, is shown in FIG. 3. The shape recognizing algorithm is applied only to pixels in the tiles in the selected regions.

In one instance, the shape recognizing algorithm is a template matching algorithm applied to every pixel in the selected regions. (one example of a template matching algorithm is given in W. K. Pratt, Digital Image Processing, ISBN 0-471-0188-0, pp. 551-553, which is incorporated by reference herein.)

In another instance, the shape recognizing algorithm is a shape matching algorithm. (A number of examples of shape matching algorithms are given in, for example, Thayananthan, A.; Stenger, B.; Torr, P. H. S.; Cipolla, R., Shape context and chamfer matching in cluttered scenes, 2003 IEEE Computer Society Conference on Computer Vision and Pattern Recognition, 2003. Proceedings, Volume 1, 18-20 Jun. 2003, Pages: I-127-I-133 vol. 1 and in Mori, G.; Belongie, S.; Malik, J, Efficient shape matching using shape contexts, IEEE Transactions on Pattern Analysis and Machine Intelligence, Volume 27, Issue 11, November 2005, Pages: 1832-1837, all of which are incorporated by reference herein. Reference is made in the above to a number of other shape matching algorithms.) The methods of these teachings are not limited to any one shape matching algorithm or to any one template matching algorithm.

The size of the tile selected is dependent on the type of image being analyzed. Factors to consider in selecting the tile size are whether the tile is going to contain a number of uninteresting pixels if it is too large or whether a large number of tiles will have to be considered in order to identify the regions in which the measure of pixel value variation exceeds the predetermined value.

In one instance, a portion of a shape may overlap several different tiles in the tessellation. This condition may cause the measure of pixel value variation in the overlapped tiles to be below the threshold in that instance, the tiles would not be analyzed and an error may result. To resolve this possible situation, in one embodiment, a dilation operation is performed on all the tiles (with boundary conditions being taken into account). (Dilation is a morphological image processing operation defined as computing, for each image pixel, the maximum value of its neighboring pixels in a defined neighborhood. See, for example, http://blogs.mathworks.com/steve/ or http://www.ph.tn.tudelft.nl/Courses/FIP/frames/fip-Morpholo.html). The dilation operation is performed utilizing a predetermined neighborhood. For example, these teachings not being limited to this example, the neighborhood could be a 2 by 2 or 3 by 3 group of tiles.

An exemplary embodiment of the application of the shape recognizing algorithm, these teachings not being limited only to that embodiment, is disclosed herein below.

In the exemplary embodiment, a template matching algorithm is applied. In a conventional template matching algorithm, a measure of how a template (that is, a desired shape), t(x,y), matches the image, described as f(x,y). In one instance, the measure use is a distance (in one instance, a Euclidean distance metric) and the measure is minimized when the crosscorrelation between the template and the image is maximum, the crosscorrelation

$${\int }_{template}^{ } t \cdot f d x d y$$

being calculated at the pixels of the image. The crosscorrelation operation can be tantamount to moving the template so that it is located over the pixel at which the operation is evaluated.

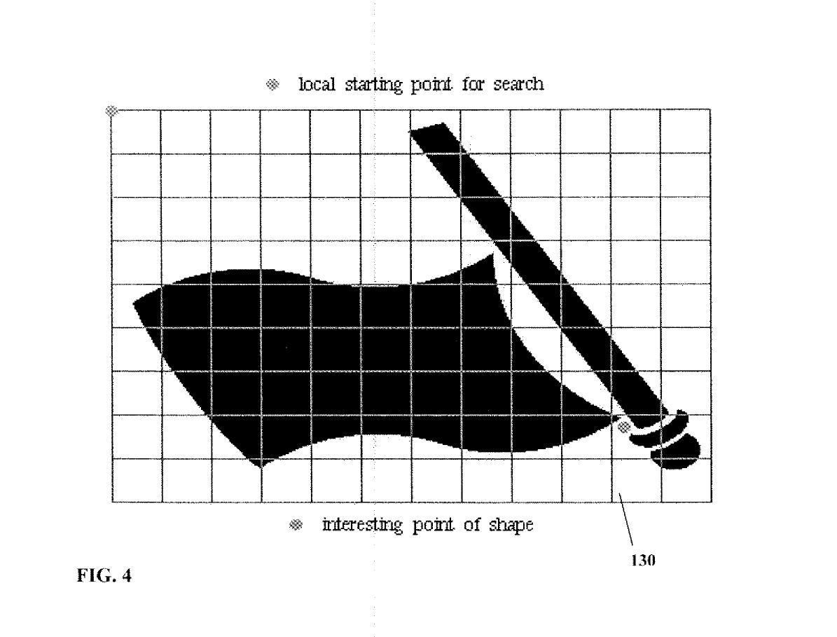

As applied in the exemplary embodiment of these teachings, the conventional template matching algorithm is modified as follows. First, a location of substantially maximum pixel activity is determined for the template. In one embodiment, the location of substantially maximum pixel activity is the location around which there are the most foreground and background pixels in the template. In another embodiment, the location of substantially maximum pixel activity is the location of substantially maximum pixel variance in a predetermined neighborhood of the pixel. Other embodiments are possible including embodiments in which the location of substantially maximum pixel activity is determined by visual inspection of the template. An exemplary embodiment of a location of substantially maximum pixel activity 130 is shown in FIG. 4.

After determining the location of substantially maximum pixel activity, the placing of the template, rather than being performed sequentially pixel by pixel, is considered sequentially tile by tile. The placing of the template at a tile, in one instance, comprises registering one corner of the template to one corner of the tile being evaluated. (In one instance, the upper left corner of the template is registered to the upper left corner of the tile being evaluated. In the image shown in FIG. 2, the determination of whether the measure of pixel value variation exceeds a threshold is usually started at one corner, for example, the uppermost left-hand corner 140.) After placing the template on the tile being evaluated, the tile over which the location of substantially maximum pixel activity of the template is located is identified. If the identified tile is not in one of the identified regions, the template is placed over a subsequent tile to be evaluated. If the identified tile is in one of the identified regions, crosscorrelations are evaluated for the template at each location in which the template can be placed without it moving into a subsequent tile. At each of these locations, the crosscorrelation of each of the pixels within the template to the corresponding pixels of the image are performed and the results are used to determine if the template matches the image. After evaluating each of these intra-tile locations, the template is placed over a subsequent tile to be evaluated and the process is repeated.

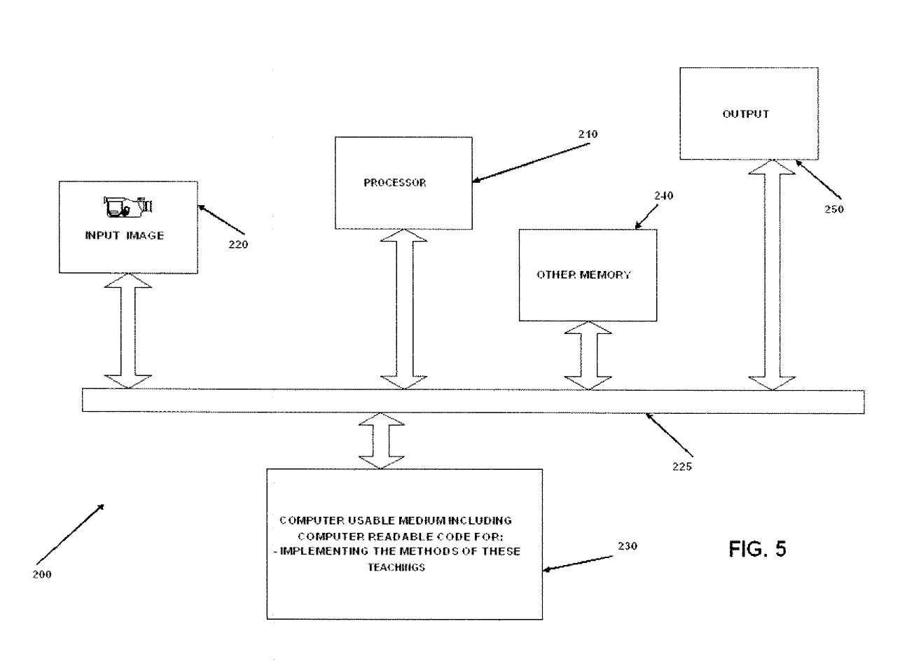

The method of this invention can be implemented by a system 200 (FIG. 5). Referring to FIG. 5, a processor 210 and supporting computer usable medium (memory, in one embodiment) 230 could be used to implement the methods of these teachings. Processor(s) 210 can be a dedicated processor, or a digital signal processor, or a general purpose processor and supporting memory 230 could be any computer usable medium. The computer usable medium has computer readable code embodied therein for causing the processor 210 to implement the methods of these teachings. An image acquisition component 220 (for example, but not limited to, a digital camera or a video camera) provides the image to the system, The other memory 240 can have other information stored therein, such as, threshold or predetermined data. An output component 250 provides means for obtaining the result of the shape identification. The image acquisition component 220, the processor (s) 210, the computer usable medium 230 and the other memory 240 are operatively connected by an interconnection component 225.

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, a carrier wave, or any other medium from which a computer can read.

Although the invention has been described with respect to various embodiments, it should be realized this invention is also capable of a wide variety of further and other embodiments within the spirit and scope of the appended claims.

What is claimed is:

1. A method for recognizing shapes in an image, the method comprising the steps of:
a. tessellating the image, resulting in a tessellation comprising a plurality of tiles, each tile from said tessellation comprising a plurality of pixels;
b. obtaining a measure of pixel value variation for one tile in the tessellation;
c. determining, for one tile from the tessellation, if the measure is at least equal to a predetermined value;
d. repeating steps (b) through (c) for another tile from the tessellation, until all tiles from the tessellation have been considered;
e. controlling application of a shape recognizing algorithm based on the determined measure for each tile.

2. The method of claim 1 wherein the tessellation comprises rectangular tiles.

3. The method of claim 1 wherein the measure is a variance of pixel values for the plurality of pixels in each tile.

4. The method of claim 1 wherein the step of controlling application of a shape recognizing algorithm comprises the steps of:
g. determining, in a template, a location of substantially maximum pixel activity;
h. Registering a corner of the template to a corner of one tile of the image;
i. Determining a location of another tile over which the location of substantially maximum pixel activity in the template is located;
j. evaluating, at each pixel in said another tile at which the template can be placed, if the measure for said another tile is at least equal to the predetermined value, a crosscorrelation with the template; and
k. Repeating steps h through j for a tile adjacent to said one tile until all tiles have been considered.

5. The method of claim 1 further comprising the step of performing a dilation operation on the measure of pixel value variation.

6. The method of claim 1 wherein the step of controlling application of a shape recognizing algorithm comprises the step of applying a template matching algorithm.

7. The method of claim one wherein the step of controlling application of a shape recognizing algorithm comprises the step of:
identifying regions in the tessellation, the measure for each tile in the regions being at least equal to the predetermined value;
applying a shape recognizing algorithm to tiles in the identified regions.

8. A system comprising:
an image acquisition component capable of acquiring an image;
at least one processor;
at least one computer usable medium having computer readable code embodied therein, said computer readable code being capable of causing said at least one processor to:
(a) tessellate the image, resulting in a tessellation comprising a plurality of tiles, each tile from said tessellation comprising a plurality of pixels;
(b) obtain a measure of pixel value variation for one tile in the tessellation;
(c) determine, for one tile from the tessellation, if the measure is at least equal to a predetermined value;
(d) repeat steps (b) through (c) for another tile from the tessellation, until all tiles from the tessellation have been considered;
(e) control application of a shape recognizing algorithm based on the determined measure for each tile.

9. The system of claim 8 wherein said measure is a variance of pixel values for the plurality of pixels in each tile.

10. The system of claim 8 wherein said computer readable code is further capable of causing said at least one processor to:
perform a dilation operation on the measure of pixel value variation.

11. The system of claim 8 wherein said computer readable code in causing said at least one processor to control application of a shape recognizing algorithm is capable of causing said at least one processor to apply a template matching algorithm.

12. The system of claim 8 wherein said computer readable code in causing said at least one processor to control application of a shape recognizing algorithm is capable of causing said at least one processor to:
identify regions in the tessellation, the measure for each tile in the regions being at least equal to the predetermined value;
apply a shape recognizing algorithm to tiles in the identified regions.

13. The system of claim 8 wherein said computer readable code in causing said at least one processor to apply a shape recognizing algorithm is capable of causing said at least one processor to:
g) determine, in a template, a location of substantially maximum pixel activity;
h) Register a corner of the template to a corner of one tile of the image;
i) Determine a location of another tile over which the location of substantially maximum pixel activity in the template is located;
j) evaluate, at each pixel in said another tile at which the template can be placed, if the measure for said another tile is at least equal to the predetermined value, a crosscorrelation with the template; and
k) repeat steps h) through j) for a tile adjacent to said one tile until all tiles have been considered.

14. A computer program product comprising:
a computer usable medium having computer readable code embodied therein, said computer readable code being capable of causing a computer system to:
(a) tessellate an image, resulting in a tessellation comprising a plurality of tiles, each tile from said tessellation comprising a plurality of pixels;
(b) obtain a measure of pixel value variation for one tile in the tessellation;
(c) determine, for one tile from the tessellation, if the measure is at least equal to a predetermined value;
(d) repeat steps (b) through (c) for another tile from the tessellation, until all tiles from the tessellation have been considered;
(e) control application of a shape recognizing algorithm based on the determined measure for each tile.

15. The computer program product of claim 14 wherein said measure is a variance of pixel values for the plurality of pixels in each tile.

16. The computer program product of claim 14 wherein said computer readable code is further capable of causing said computer system to:
perform a dilation operation on the measure of pixel value variation.

17. The computer program product of claim 14 wherein said computer readable code in causing said computer system to control application of a shape recognizing algorithm is capable of causing said computer system to apply a template matching algorithm.

18. The computer program product of claim 14 wherein said computer readable code in causing said computer system to control application of a shape recognizing algorithm is capable of causing said computer system to:
identity regions in the tessellation, the measure for each tile in the regions being at least equal to the predetermined value;
apply the shape recognizing algorithm to tiles in the identified regions.

19. The computer program product of claim 14 wherein said computer readable code in causing said computer system to control application of a shape recognizing algorithm is capable of causing said computer system to:
g) determine, in a template, a location of substantially maximum pixel activity;
h) register a corner of the template to a corner of one tile of the image;
i) determine a location of another tile over which the location of substantially maximum pixel activity in the template is located;
j) evaluate, at each pixel in said another tile at which the template can be placed, if the measure for said another tile is at least equal to the predetermined value, a crosscorrelation with the template; and
k) repeat steps h) through j) for a tile adjacent to said one tile until all tiles have been considered.

20. A method for recognizing shapes in an image, the method comprising the steps of:
a. tessellating the image, resulting in a tessellation comprising a plurality of tiles, each tile from said tessellation comprising a plurality of pixels;
b. obtaining a measure of pixel value variation for one tile in the tessellation;
c. determining, for one tile from the tessellation, if the measure is at least equal to a predetermined value;
d. repeating steps (b) through (c) for another tile from the tessellation, until all tiles from the tessellation have been considered;
e. determining, in a template, a location of substantially maximum pixel activity;
f. registering a corner of the template to a corner of one tile of the image;
g. determining a location of another tile over which the location of substantially maximum pixel activity in the template is located;
h. evaluating, at each pixel in said another tile at which the template can be placed, if the measure for said another tile is at least equal to the predetermined value, a crosscorrelation with the template; and
i. repeating steps f through h for a tile adjacent to said one tile until all tiles have been considered.
